(19) United States
(12) Patent Application Publication
(10) Pub. No.: US 2024/0353640 A1
(43) Pub. Date: Oct. 24, 2024

(54) ALL-DRY OPTICAL FIBER RIBBON CABLE

(71) Applicant: Jiangsu Zhongtian Technology Co., Ltd., Jiangsu (CN)

(72) Inventors: Jing ZHAO, Jiangsu (CN); Jianqiu XU, Jiangsu (CN); Pengyu ZHU, Jiangsu (CN); Weiwei MIAO, Jiangsu (CN); Xiaoming MIAO, Jiangsu (CN); Huihui QIAN, Jiangsu (CN); Feng TAN, Jiangsu (CN); Xiaohua MIAO, Jiangsu (CN)

(73) Assignee: Jiangsu Zhongtian Technology Co., Ltd., Jiangsu (CN)

(21) Appl. No.: 18/755,578

(22) Filed: Jun. 26, 2024

Related U.S. Application Data
(63) Continuation of application No. PCT/CN2024/073890, filed on Jan. 24, 2024.

(30) Foreign Application Priority Data
Apr. 13, 2023 (CN) 202310389314.4

(51) Int. Cl. G02B 6/44

(52) U.S. Cl. CPC G02B 6/44384

(57) ABSTRACT

The present application provides an all-dry optical fiber ribbon cable, including an optical unit, a first buffer layer, a first waterproof layer, a loose tube, a second waterproof layer, an armor layer, and a protective layer; where the optical unit includes a plurality of fiber ribbons; the first buffer layer, the first waterproof layer, the loose tube, the second waterproof layer, the armor layer, and the protective layer are sequentially sleeved over the plurality of fiber ribbons. The first buffer layer is a high elastic polymer material layer, and a Shore hardness of the first buffer layer is 45HA-85HA, a tensile strength of the first buffer layer is greater than or equal to 10 MPA, a breaking elongation of first buffer layer is 200%-600%, and a compression permanent deformation rate of the first buffer layer is less than or equal to 30%.

### CROSS-REFERENCE TO RELATED APPLICATION

The present application is a continuation of International Application No. PCT/CN2024/073890, filed on Jan. 24, 2024, which claims priority to Chinese Patent Application No 202310389314.4, filed on Apr. 13, 2023, both of the applications are incorporated herein by reference in their entireties.

### TECHNICAL FIELD

The present application relates to the technical field of optical communications and, in particular, to an all-dry optical fiber ribbon cable.

### BACKGROUND

Optical fiber ribbon cables are widely used in mobile base stations, data centers, residence communities and other occasions.

The optical fiber ribbon cable can be divided into a filled optical fiber ribbon cable and an all-dry optical fiber ribbon cable according to its water blocking manner, where the filled optical fiber ribbon cable is filled with ointment in a loose tube to achieve water blocking effect, in addition, the ointment can lubricate a fiber ribbon in the filled optical fiber ribbon cable and buffer external pressure thereon. During the process of laying optical cables, when in need to connect the filled optical fiber ribbon cable, it is necessary to remove the ointment at the connection, and the difficulty of removing the ointment makes the efficiency of laying the optical cables lower. The all-dry optical fiber ribbon cable blocks water through its waterproof layer, without the need to remove the ointment during the laying process, so the laying efficiency of the all-dry optical cable is relatively high.

However, the fiber ribbon in the all-dry optical fiber ribbon cable is prone to damage and the attenuation of light transmitted in the fiber ribbon is large.

### SUMMARY OF THE INVENTION

The present application provides an all-dry optical fiber ribbon cable that can reduce the deformation or damage of fiber ribbons caused by the extrusion from a first waterproof layer and a loose tube, and can also reduce the attenuation of light conducted in the fiber ribbons due to the deformation of the fiber ribbons.

The present application provides an all-dry optical fiber ribbon cable, including an optical unit, a first buffer layer, a first waterproof layer, a loose tube, a second waterproof layer, an armor layer, and a protective layer; where the optical unit includes a plurality of fiber ribbons arranged in an array; the first buffer layer, the first waterproof layer, the loose tube, the second waterproof layer, the armor layer, and the protective layer are sequentially sleeved over the plurality of fiber ribbons.

The first buffer layer is used to separate the fiber ribbons from the first waterproof layer, the first buffer layer is a high elastic polymer material layer, and a Shore hardness of the first buffer layer is 45HA-85HA, a tensile strength of the first buffer layer is greater than or equal to 10 MPA, a breaking elongation of the first buffer layer is 200%-600%, and a compression permanent deformation rate of the first buffer layer is less than or equal to 30%;
the first buffer layer includes a plurality of first buffer portions or a plurality of second buffer portions, the plurality of first buffer portions are arranged along an axial direction of the optical unit, and there is a first spacing between two adjacent first buffer portions along the axial direction of the optical unit.

In a possible implementation, according to the all-dry optical fiber ribbon cable provided in the present application, the plurality of first buffer portions are uniformly spaced along the axial direction of the optical unit.

In a possible implementation, according to the all-dry optical fiber ribbon cable provided in the present application, the plurality of first buffer portions are sequentially connected end-to-end along the axial direction of the optical unit to form the first buffer layer in a spiral shape along the axial direction of the optical unit.

In a possible implementation, according to the all-dry optical fiber ribbon cable provided in the present application, the first buffer portion includes at least one first buffer strip. In a possible implementation, according to the all-dry optical fiber ribbon cable provided

in the present application, the plurality of second buffer portions are arranged along a circumferential direction of the optical unit.

In a possible implementation, according to the all-dry optical fiber ribbon cable provided in the present application, the plurality of second buffer portions are arranged at intervals along the circumferential direction of the optical unit.

In a possible implementation, according to the all-dry optical fiber ribbon cable provided in the present application, the plurality of second buffer portions are sequentially abutted along the circumferential direction of the optical unit.

In a possible implementation, according to the all-dry optical fiber ribbon cable provided in the present application, the plurality of fiber ribbons are arranged in an array to form a polygon in a cross-section of the optical unit, and a side of the second buffer portion facing the optical unit is a plane to abut against a side edge of the optical unit;
a side of the second buffer portion facing the first waterproof layer is a camber surface to abut against an inner ring of the first waterproof layer.

In a possible implementation, according to the all-dry optical fiber ribbon cable provided in the present application, the first buffer layer is an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6-octadiene, 5,7-dimethyl-1,6-octadiene or 7-methyl-1,6-octadiene.

In a possible implementation, according to the all-dry optical fiber ribbon cable provided in the present application, the all-dry optical fiber ribbon cable further includes a second buffer layer, the second buffer layer is located between the first waterproof layer and the loose tube.

In a possible implementation, according to the all-dry optical fiber ribbon cable provided in the present application, there are, at least, two first waterproof layers, and the two first waterproof layers are sequentially wound around the first buffer layer, the first waterproof layer located on an inner side forms a first interface, and the first waterproof layer located on an outer side forms a second interface, the first interface and the second interface are staggered along a circumferential direction of the optical unit;
there are, at least, two second waterproof layers, and the two second waterproof layers are sequentially wound around the loose tube, the second waterproof layer located on an inner side forms a third interface, and the second waterproof layer located on an outer side forms a fourth interface, the third interface and the fourth interface are staggered along the circumferential direction of the optical unit.

In a possible implementation, according to the all-dry optical fiber ribbon cable provided in the present application, the first waterproof layer and the second waterproof layer both include a cross-linked polyacrylic acid resin layer, a waterproof yarn and a polyethylene terephthalate fiber nonwoven fabric, and the waterproof yarn is located between the cross-linked polyacrylic acid resin layer and the polyethylene terephthalate fiber nonwoven fabric.

In a possible implementation, according to the all-dry optical fiber ribbon cable provided in the present application, a relationship among a circumference W₁ of the first waterproof layer, a diameter D₁ of a circumcircle of the optical unit, and a thickness H of the first buffer layer is:

$${W}_{1} = \frac{π ( {D}_{1} + 2 H )}{K * ( 1 - N )} ,$$

a relationship between a circumference W₂ of the second waterproof layer and a diameter D₂ of the loose tube is:

$${W}_{2} = \frac{π {D}_{2}}{1 - M} .$$

In a possible implementation, according to the all-dry optical fiber ribbon cable provided in the present application, the loose tube is made of thermoplastic polyester material formed by 30%-70% by mass of polybutylene terephthalate (PBT), 25%-60% by mass of amorphous polytetrahydrofuran (PTMG), and 5%-10% by mass of maleic anhydride or glycidyl methacrylate.

The present application provides an all-dry optical fiber ribbon cable, where an optical unit, a first buffer layer, a first waterproof layer, a loose tube and an armor layer are disposed; where the optical unit includes a plurality of fiber ribbons; and the first buffer layer, the first waterproof layer, the loose tube, and the armor layer are sequentially sleeved over the plurality of fiber ribbons. The first buffer layer is used to separate the fiber ribbons from the first waterproof layer, a Shore hardness of the first buffer layer is 45HA-85HA, a tensile strength of the first buffer layer is greater than or equal to 10 MPA, a breaking elongation of the first buffer layer is 200%-600%, and a compression permanent deformation rate of the first buffer layer is less than or equal to 30%. Thereby, it can be ensured that the first buffer layer has high elasticity and toughness, and can provide good protection for the optical unit when being subjected to external impact. A first spacing is set between two adjacent first buffer portions. When laying the all-dry optical fiber ribbon cable, the first buffer portions disposed at intervals on the curved laying path can also provide free space for the optical unit to move. Therefore, by disposing the first buffer layer and setting the first spacing between two adjacent first buffer portions in the first buffer layer, the pressure applied by the first waterproof layer and the loose tube on the optical unit can be reduced, thereby reducing the deformation or damage of the fiber ribbons in the optical unit caused by the extrusion from the first waterproof layer and the loose tube, and the attenuation of light conducted in the fiber ribbons due to the deformation of the fiber ribbons can be reduced.

### BRIEF DESCRIPTION OF THE DRAWINGS

In order to more clearly illustrate the technical solutions in the embodiments of the present application or the related art, the following will briefly introduce the accompanying drawings that need to be used in the description of the embodiments or the existing technology, and it will be obvious that the accompanying drawings in the following description are intended for some of the embodiments of the present application. For an ordinary person skilled in the art, other drawings can be obtained based on these accompanying drawings without creative labor.

FIG. 1 is a first schematic structural diagram of an all-dry optical fiber ribbon cable provided in an embodiment of the present application.

FIG. 2 is a first schematic structural diagram of a first buffer layer in an all-dry optical fiber ribbon cable provided in an embodiment of the present application.

FIG. 3 is a second schematic structural diagram of a first buffer layer in an all-dry optical fiber ribbon cable provided in an embodiment of the present application.

FIG. 4 is a schematic structural diagram of a first buffer portion in an all-dry optical fiber ribbon cable provided in an embodiment of the present application.

FIG. 5 is a second schematic structural diagram of an all-dry optical fiber ribbon cable provided in an embodiment of the present application.

FIG. 6 is a third schematic structural diagram of an all-dry optical fiber ribbon cable provided in an embodiment of the present application.

FIG. 7 is a fourth schematic structural diagram of an all-dry optical fiber ribbon cable provided in an embodiment of the present application.

FIG. 8 is a fifth schematic structural diagram of an all-dry optical fiber ribbon cable provided in an embodiment of the present application.

FIG. 9 is a schematic structural diagram of a first waterproof layer in an all-dry optical fiber ribbon cable provided in an embodiment of the present application.

FIG. 10 is a schematic structural diagram of a second waterproof layer in an all-dry optical fiber ribbon cable provided in an embodiment of the present application.

### DESCRIPTION OF REFERENCE NUMBERS

100—optical unit; 110—fiber ribbon;
200—first buffer layer; 210—first buffer portion; 210a—first end; 210b—second end; 211—first buffer strip; 220—second buffer portion; 221—second buffer strip;
300—first waterproof layer; 310—first interface; 320—second interface;
400—loose tube;
500—armor layer;
600—second buffer layer;
700—second waterproof layer; 710—third interface; 720—fourth interface;
800—protective layer; 810—enhancement element;
L1—first spacing;
L—axial direction of optical unit;
C—circumferential direction of optical unit.

### DETAILED DESCRIPTION OF THE EMBODIMENTS

In order to make purposes, technical solutions and advantages of the embodiments of the present application clearer, the technical solutions in the embodiments of the present application will be described clearly and completely in the following in conjunction with the accompanying drawings in the embodiments of the present application, and it is obvious that the described embodiments are a part of the embodiments of the present application, rather than all of the embodiments. Based on the embodiments in the present application, all other embodiments obtained by an ordinary person skilled in the art without creative labor are within the protection scope of the present application.

In the description of the present application, it should be noted that, unless otherwise expressly provided and limited, the terms “mount”, “connect to”, “connect with” are to be understood in a broad sense, for example, they may be a fixed connection, an indirect connection through an intermediary medium, a communication between interiors of two elements, or an interaction relationship between two elements. For those ordinary skilled in the art, the specific meanings of the above terms in the present application can be understood based on specific situations.

In the description of the present application, it should be understood that the terms “upper”, “lower”, “front”, “back”, “vertical”, “horizontal”, “top”, “bottom”, “inner”, “outer” and the like indicate orientation or positional relationships based on those shown in the accompanying drawings, and are used only for the purpose of facilitating the description of the present application and simplifying the description, and do not indicate or imply that the apparatuses or elements referred to must have a particular orientation, be constructed and operated in a particular orientation, and therefore cannot be interpreted as a limitation of the present application.

The terms “first”, “second”, “third”, “fourth”, etc. (if any) in the specification and claims of the present application, as well as the accompanying drawings described above, are used to distinguish similar objects but not to describe a particular order or sequence. It should be understood that the data used in this way may be interchanged in appropriate circumstances, so that the embodiments described herein may be implemented in an order other than those illustrated or described herein.

In addition, the terms “include” and “have”, and any variations thereof, are intended to cover non-exclusive inclusions, e.g., processes, methods, systems, products or tools that include a series of steps or units are not necessarily limited to those that are clearly listed, but may include other steps or units that are not clearly listed or are inherent to these processes, methods, products or tools.

The optical fiber ribbon cable is superior to the traditionally structured optical cable in terms of welding efficiency and fiber density. Therefore, the optical fiber ribbon cable is widely used in a core layer and backbone section of the access layer of metro optic cables, especially in situations with high data transmission rates and connection densities (such as a mobile base station, a data center, a residence community, etc.).

The optical fiber ribbon cable includes fiber ribbons and a loose tube sleeved over the outer sides of the fiber ribbons, the optical fiber ribbon cable can be divided into a filled optical fiber ribbon cable and an all-dry optical fiber ribbon cable according to its water blocking manner, where the filled optical fiber ribbon cable is filled with ointment in the loose tube to achieve water blocking effect, in addition, the ointment can lubricate the fiber ribbons in the filled optical fiber ribbon cable and buffer external pressure thereon.

With the advancement of optical communication networks towards high capacity and high speed, the number of optic cable cores is increasing. During the process of laying optical cables, when in need to connect the filled optical fiber ribbon cable, it is necessary to remove the ointment at the connection, and the difficulty of removing the ointment makes the efficiency of laying the optical cables lower.

Whereas, a waterproof layer is disposed between the fiber ribbon and the loose tube of the all-dry optical fiber ribbon cable to block water, the water is blocked through the waterproof layer, and thus there is no need to remove the ointment during the laying process, the laying efficiency of the all-dry optical cable is relatively high.

However, due to the lack of lubrication and buffering effect of the ointment, the fiber ribbon in the all-dry optical fiber ribbon cable is prone to damage and the attenuation of light transmitted in the fiber ribbon is large.

Based on this, the present application provides an all-dry optical fiber ribbon cable that can reduce the deformation or damage of the optical fiber ribbon caused by the extrusion the first waterproof layer and the loose tube, and can also reduce the attenuation of light conducted in the fiber ribbon due to the deformation of the fiber ribbon.

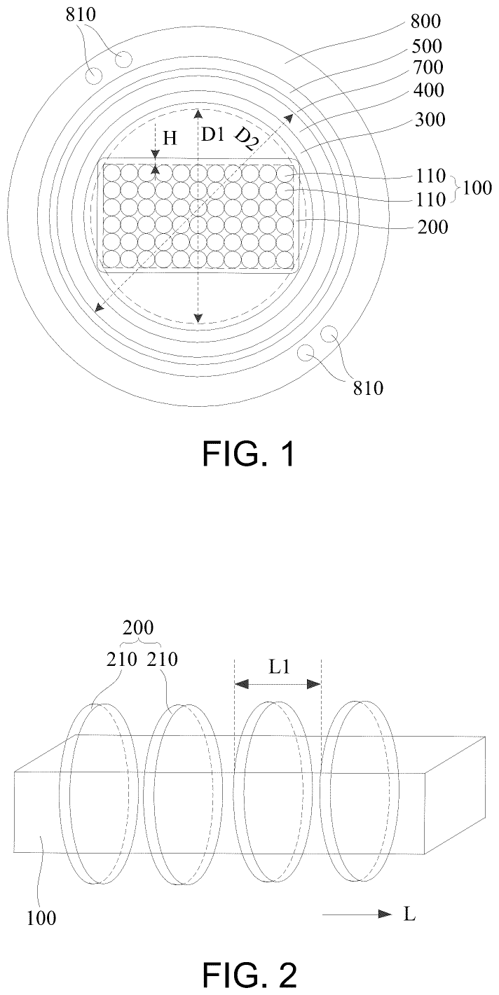

FIG. 1 is a first schematic structural diagram of an all-dry optical fiber ribbon cable provided in an embodiment of the present application; FIG. 2 is a first schematic structural diagram of a first buffer layer in an all-dry optical fiber ribbon cable provided in an embodiment of the present application.

As shown in FIGS. 1 and 2, an all-dry optical fiber ribbon cable provided in the present application includes an optical unit 100, a first buffer layer 200, a first waterproof layer 300, a loose tube 400, a second waterproof layer 700, an armor layer 500, and a protective layer; where the optical unit 100 includes a plurality of fiber ribbons 110 arranged in an array; the first buffer layer 200, the first waterproof layer 300, the loose tube 400, the second waterproof layer 700, the armor layer 500, and the protective layer 800 are sequentially sleeved over the plurality of fiber ribbons 110; the first buffer layer 200 is used to separate the fiber ribbons 110 from the first waterproof layer 300, the first buffer layer 200 is a high elastic polymer material layer, and a Shore hardness of the first buffer layer 200 is 45HA-85HA, a tensile strength of the first buffer layer 200 is greater than or equal to 10 MPA, a breaking elongation of the first buffer layer 200 is 200%-600%, and a compression permanent deformation rate of the first buffer layer 200 is less than or equal to 30%; the first buffer layer 200 includes a plurality of first buffer portions 210, the plurality of first buffer portions 210 are arranged along an axial direction of the optical unit 100, and there is a first spacing L1 between two adjacent first buffer portions 210 along the axial direction of the optical unit 100.

Specifically, with continued reference to FIG. 1, the optical unit 100 includes a plurality of fiber ribbons 110, the number of cores of each fiber ribbon 110 can be 4 to 36, the number of fiber ribbons 110 included in the optical unit 100 can be 4 to 36. Therefore, the total number of optical fiber cores included in the optical unit 100 can be 16 to 1296.

The fiber ribbons are arranged in an array to present the cross-section of the optical unit 100 as a polygon, such as a rectangle, a rhombus, a pentagon, a hexagon, etc. When the cross-section of the optical unit 100 is a rectangle, the length ratio of two adjacent sides of the rectangle can be 0.7 to 1.0; when the cross-section of the optical unit 100 is a rhombus, the length ratio of two diagonals of the rhombus can be 0.7 to 1.0; when the cross-section of the optical unit 100 is a pentagon, the length ratio of the shortest diagonal to the longest diagonal of the pentagon can be 0.7 to 1.0, and so on. As a result, the cross-sectional area of the circumcircle of the optical unit 100 can be minimized, and the number of optical fiber cores in a small cross-section of the optical unit 100 is maximized. At the same time, it is conducive to improving the combination molding effect of the array formed by the fiber ribbons 110, and it is easy for the cross-sectional shape of the optical unit 100 to fit with the first buffer layer 200. In addition, it is also convenient for the extrusion molding of the loose tube 400 and to improve the water blocking effect inside the loose tube 400.

The first buffer layer 200 is disposed between the optical unit 100 and the first waterproof layer 300. The first buffer layer 200 is made of high elastic polymer material. The first buffer layer 200 has the characteristics of lightweight, cold resistance, heat resistance, aging resistance, and hydrolysis resistance, and can be deformed under external forces and restore to its original state after the external forces are removed. Therefore, by disposing the first buffer layer 200 between the optical unit 100 and the first waterproof layer 300, the pressure applied by the first waterproof layer 300 and the loose tube 400 on the optical unit 100 can be reduced, thereby avoiding the deformation or damage of the fiber ribbons 110 in the optical unit 100 caused by the extrusion from the first waterproof layer 300 and the loose tube 400, and the attenuation of light conducted in the fiber ribbons 110 due to the deformation of the fiber ribbons 110 can be reduced.

In the following, the characteristics of the first buffer layer 200 will be described.

A Shore hardness of the first buffer layer 200 is 45HA-85HA, a tensile strength of the first buffer layer 200 is greater than or equal to 10 MPA, a breaking elongation of the first buffer layer 200 is 200%-600%, and a compression permanent deformation rate of the first buffer layer 200 is less than or equal to 30%. Thereby, it can be ensured that the first buffer layer 200 has high elasticity and toughness, and can provide good protection for the optical unit 100 when being subjected to external impact.

The first buffer layer 200 can be an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6-octadiene, 5,7-dimethyl-1,6-octadiene or 7-methyl-1,6-octadiene.

Specifically, the ethylene-propylene rubber layer can be a terpolymer formed by copolymerization of monoolefin ethylene, propylene and other olefin as a monomer (such as one or more of 5-ethylidene-2-norbornene, dicyclopentadiene, 6,10-dimethyl-1,5,9-undenetriene, 3,7-dimethyl-1,6-octadiene, 5,7-dimethyl-1,6-octadiene, 7-methyl-1,6-octadiene). The first buffer layer 200 can also be other high elastic rubbers.

When the thickness of the first buffer layer 200 is 1.0-2.5 mm, and the thickness of the first buffer layer 200 is less than 1.0 mm, it is difficult to play a buffering role; and when the thickness of the first buffer layer 200 is greater than 2.5 mm, the volume and weight of the all-dry optical fiber ribbon cable will be increased.

In addition, the density of the first buffer layer 200 is 0.85g/cm³-1.15g/cm³. A smaller density makes the weight of the first buffer layer 200 lighter, which in turn makes the weight of the all-dry optical fiber ribbon cable using the first buffer layer 200 lighter. The temperature resistance range of the first buffer layer 200 is −40° C.-150° C. Thus, the first buffer layer 200 is suitable for various usage environments of the all-dry optical fiber ribbon cable.

In FIG. 2, the optical unit 100 is schematically shown as a rectangular prism, and the first buffer portion 210 in the first buffer layer 200 is schematically shown as a circular ring.

With continued reference to FIG. 2, the extension direction of the fiber ribbon 110 in the optical unit 100 is called an axial direction L of the optical unit. The first buffer portion 210 can be a ring-shaped component sleeved over the optical unit 100. The plurality of first buffer portions 210 are sequentially sleeved over the optical unit 100 along the axial direction L of the optical unit. The spacing distance between adjacent first buffer portions 210 is called a first spacing L1.

The first spacing L1 is set between two adjacent first buffer portions 210, which not only can save the amount of material used in the first buffer layer 200, but also further reduce the weight of the all-dry optical fiber ribbon cable. In addition, when laying the all-dry optical fiber ribbon cable, the first buffer portions 210 disposed at intervals on the curved laying path can also provide free space for the optical unit 100 to move, thereby further reducing the deformation or damage of the optical unit 100 caused by the extrusion from the first waterproof layer 300 and the loose tube 400 during bending.

The first waterproof layer 300 is sleeved outside the first buffer layer 200 to achieve water blocking for the all-dry optical fiber ribbon cable.

The loose tube 400 is sleeved outside the first waterproof layer 300, and the loose tube 400 is used to protect the optical unit 100 and the first waterproof layer 300. The loose tube 400 is made of thermoplastic polyester material formed by 30%-70% by mass of polybutylene terephthalate (PBT), 25%-60% by mass of amorphous polytetrahydrofuran (PTMG), and 5%-10% by mass of maleic anhydride or glycidyl methacrylate.

The loose tube 400 can be formed by extrusion processing or other methods. In this embodiment, the loose tube 400 is formed by extrusion processing. The loose tube 400 formed by extrusion processing has good tensile strength, lateral pressure resistance, and dimensional stability of molding, as well as good toughness and impact strength. It is suitable for covering a large number (288 and above) of cores of the fiber ribbons 110. The minimum bending radius of the loose tube 400 formed by extrusion processing can reach 15 times the diameter of the fiber ribbon 110.

With continued reference to FIG. 1, in order to improve the water blocking effect of the all-dry optical fiber ribbon cable, the all-dry optical fiber ribbon cable also includes a second waterproof layer 700, the second waterproof layer 700 is sleeved over the outside of the loose tube 400.

The armor layer 500 is sleeved over the outside of the second waterproof layer 700. The armor layer 500 is used to increase the mechanical strength of the all-dry optical fiber ribbon cable and improve its anti-corrosion ability. The armor layer 500 can be formed from metal material, such as steel wire, steel strip, or aluminum strip. The armor layer 500 can also be formed from non-metal material, such as glass fibers, carbon fibers, fiber filaments reinforced with aramid fibers, or composite plastic rods. The armor layer 500 can be single-layered or double-layered.

With continued reference to FIG. 1, the all-dry optical fiber ribbon cable also includes a protective layer 800. The protective layer 800 can be single-layered, double-layered, or multilayered, and specific settings depend on the usage environment of the all-dry optical fiber ribbon cable. The protective layer 800 can be made of high-density polyolefin material; it can also be made of nylon material, such as PA6, PA12, etc.; or it can be made of thermoplastic elastomer material, such as TPV, TPU, TPEE, etc.; or it can be made of low smoke halogen-free flame-retardant material. High modulus enhancement elements 810 with a set specification and number are symmetrically embedded within the protective layer 800 along the axial direction L of the optical unit to meet the demand for tensile properties of the all-dry optical fiber ribbon cable.

The present application provides an all-dry optical fiber ribbon cable, where an optical unit 100, a first buffer layer 200, a first waterproof layer 300, a loose tube 400, and an armor layer 500 are disposed; where the optical unit 100 includes a plurality of fiber ribbons 100; and the first buffer layer 200, the first waterproof layer 300, the loose tube 400, and the armor layer 500 are sequentially sleeved over the plurality of fiber ribbons 110. The first buffer layer 200 is used to separate the fiber ribbons 110 from the first waterproof layer 300, a Shore hardness of the first buffer layer 200 is 45HA-85HA, a tensile strength of the first buffer layer 200 is greater than or equal to 10 MPA, a breaking elongation of the first buffer layer 200 is 200%-600%, and a compression permanent deformation rate of the first buffer layer 200 is less than or equal to 30%. Thereby, it can be ensured that the first buffer layer 200 has high elasticity and toughness, and can provide good protection for the optical unit 100 when being subjected to external impact. A first spacing Ll is set between two adjacent first buffer portions 210. When laying the all-dry optical fiber ribbon cable, the first buffer portions 210 disposed at intervals on the curved laying path can also provide free space for the optical unit 100 to move. Therefore, by disposing the first buffer layer 200 and setting the first spacing L1 between two adjacent first buffer portions 210 in the first buffer layer 200, the pressure applied by the first waterproof layer 300 and the loose tube 400 on the optical unit 100 can be reduced, thereby reducing the deformation or damage of the fiber ribbons 110 in the optical unit 100 caused by the extrusion from the first waterproof layer 300 and the loose tube 400, and the attenuation of light conducted in the fiber ribbons 110 due to the deformation of the fiber ribbons 110 can be reduced.

In the following, the manner in which the first buffer layer 200 is disposed on the optical unit 100 will be specifically explained.

With continued reference to FIG. 2, the plurality of first buffer portions 210 are uniformly spaced along the axial direction of the optical unit 100.

The first spacing L1 can be set according to different cross-sectional areas of the optical unit 100, and the first spacing L1 can be 10 mm-100 mm. In the embodiment, there is an equal first spacing L1 between two adjacent first buffer portions 210, thereby, the force on the optical unit 100 is uniform.

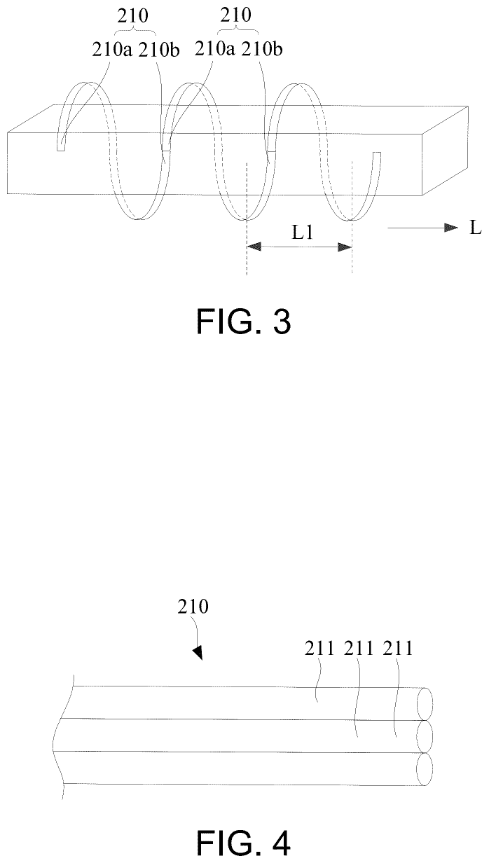

FIG. 3 is a second schematic structural diagram of a first buffer layer in an all-dry optical fiber ribbon cable provided in an embodiment of the present application. In FIG. 3, the optical unit 100 is schematically shown as a rectangular prism, and the first buffer portion 210 in the first buffer layer 200 is schematically shown as a ring-shaped component with a certain inclination relative to the axial direction L of the optical unit.

As shown in FIG. 3, in some embodiments, the plurality of first buffer portions 210 are sequentially connected end-to-end along the axial direction of the optical unit to form the first buffer layer 200 in a spiral shape along the axial direction of the optical unit.

Specifically, with continued reference to FIG. 3, the first buffer portion 210 is sleeved over the optical unit 100, the first buffer portion 210 is a ring-shaped component with a certain inclination relative to the axial direction L of the optical unit, the first buffer portion 210 includes a first end 210a and a second end 210b, where a first end 210a of a first buffer portion 210 is sequentially connected to a second end 210b of an adjacent first buffer portion 210, thereby forming the first buffer layer 200 in a spiral shape along the axial direction L of the optical unit.

It may be understood that in this embodiment, the first buffer layer 200 in the spiral shape is separated into a plurality of first buffer portions 210 merely for ease of description. In actual production, the plurality of first buffer portions 210 are integrally formed. The spiral wound manner allows the first buffer layer 200 to be more securely sleeved over the optical unit 100. In addition, in this embodiment, there is also a first spacing L1 between adjacent first buffer portions 210.

In the following, the structure of the first buffer portion 210 will be described.

FIG. 4 is a schematic structural diagram of a first buffer portion in an all-dry optical fiber ribbon cable provided in an embodiment of the present application. FIG. 4 shows the schematic structural diagram of the first buffer portion 210 before being sleeved over the optical unit 100.

As shown in FIG. 4, the first buffer portion 210 includes at least one first buffer strip 211. Specifically, the first buffer portion 210 may include one first buffer strip 211, of which the cross section can be circular, elliptical, rectangular or other shapes, as long as it is convenient for the first buffer strip 211 to be sleeved over the optical unit 100.

The first buffer portion 210 may also include two or more first buffer strips 211. In this embodiment, description is made to an example where the first buffer portion 210 includes three first buffer strips 211. With continued reference to FIG. 4, the three first buffer strips 211 are sequentially abutted. The width of the first buffer portion 210 including the three first buffer strips 211 is greater than that of the first buffer portion 210 including one first buffer strip 211, that is to say, the contact area between the first buffer portion 210 including three first buffer strips 211 and the optical unit 100 is larger, and as a result, a better protection for the optical unit can be provided.

In addition, when the first buffer portion 210 is sleeved over the optical unit 100, a tension of 0.5N to 5N can be applied to the first buffer portion 210 to maintain the first buffer portion 210 at a tensile elongation of 0.1 to 0.5 times the breaking elongation. This allows the first buffer portion 210 to come into contact with the surface of the optical unit 100 to ensure that the first buffer portion 210 will not loosen, and at the same time, the first buffer portion 210 can also play a fixing role on the optical unit 100.

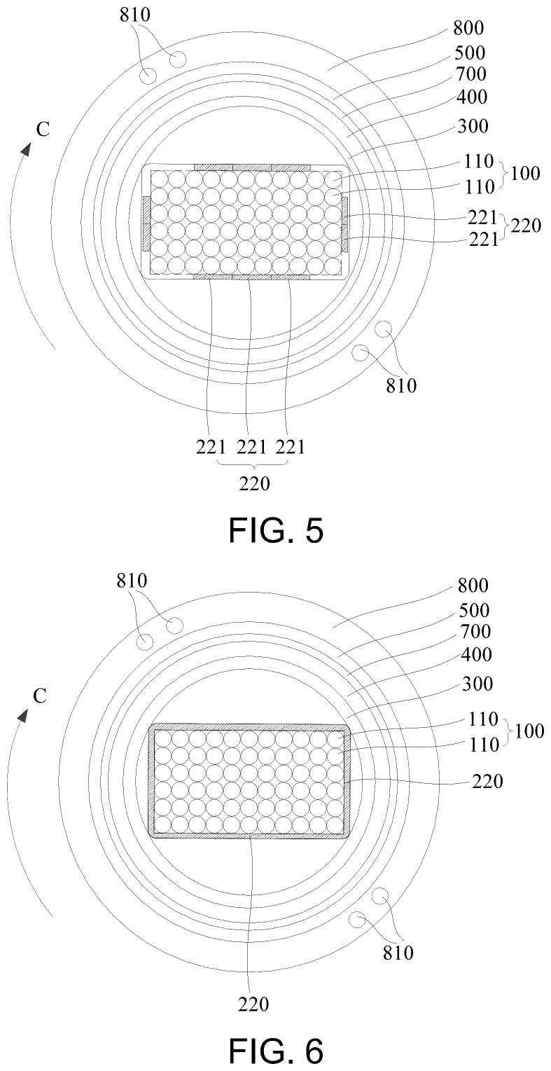

FIG. 5 is a second schematic structural diagram of an all-dry optical fiber ribbon cable provided in an embodiment of the present application. As shown in FIG. 5, a plurality of second buffer portions 220 are arranged along a circumferential direction of the optical unit 100. In some embodiments, the plurality of second buffer portions 220 are arranged at intervals along the circumferential direction of the optical unit 100.

The second buffer portion 220 may include a plurality of second buffer strips 221, and in the embodiment shown in FIG. 5, the cross-section of the second buffer strip 221 is a rectangle.

In the embodiment shown in FIG. 5, the second buffer portion 220 located on the long side of the optical unit 100 includes three second buffer strips 221, and the second buffer portion 220 located on the short side of the optical unit 100 includes two second buffer strips 221.

The circumferential direction of the optical unit 100 is called the circumferential direction C of the optical unit, and the second buffer portions 220 are arranged at intervals along the circumferential direction C of the optical unit to separate the first waterproof layer 300 from the optical unit 100.

FIG. 6 is a third schematic structural diagram of an all-dry optical fiber ribbon cable provided in an embodiment of the present application. As shown in FIG. 6, in some embodiments, the plurality of second buffer portions 220 are sequentially abutted along the circumferential direction of the optical unit 100.

The plurality of second buffer portions 220 work together to form the first buffer layer 200, which is equivalent to the optical unit 100 being wrapped in the first buffer layer 200, and as a result, a better protection for the optical unit 100 can be provided.

In addition, on the side of the first buffer layer 200 facing the optical unit, waterproof yarn or waterproof powder is also filled between two adjacent second buffer strips 221, thereby further improving the water blocking performance in the enclosed space formed after the first buffer layer 200 is wrapped.

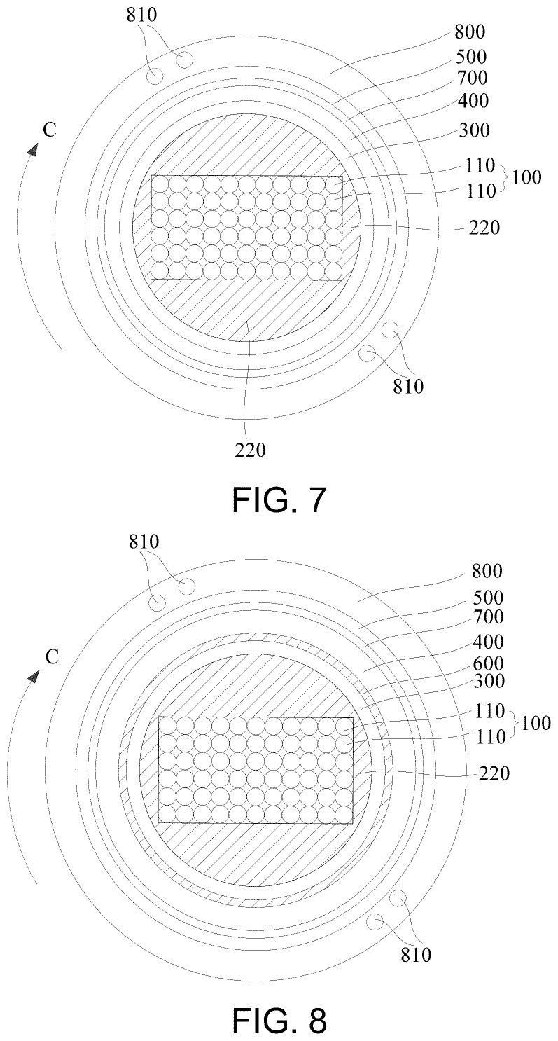

FIG. 7 is a fourth schematic structural diagram of an all-dry optical fiber ribbon cable provided in an embodiment of the present application. As shown in FIG. 7, the plurality of fiber ribbons 110 are arranged in an array to form a polygon in a cross-section of the optical unit 100, and a side of the second buffer portion 220 facing the optical unit 100 is a plane to abut against a side edge of the optical unit 100; a side of the second buffer portion 220 facing the first waterproof layer 300 is a camber surface to abut against an inner ring of the first waterproof layer 300.

As mentioned above, the cross-section of the optical unit 100 may appear as a polygon, such as a rectangle, a rhombus, a pentagon, a hexagon, etc. In this embodiment, the cross-section of the optical unit 100 is illustrated as a rectangle. The optical unit 1000 includes four sides, the four sides are respectively disposed with a second buffer portion 220, and the four second buffer portions 220 are sequentially abutted end to end to form a cylindrical first buffer layer 200. A side of the second buffer portion 220 facing the optical unit 100 is a plane to abut against a side edge of the optical unit 100.

A side of the second buffer portion 220 facing the first waterproof layer 300 is a camber surface, the sides of four second buffer portions 220 facing the first waterproof layer 300 form a complete circular surface, which has the same curvature as the inner ring of the first waterproof layer 300, to abut against the inner ring of the first waterproof layer 300.

FIG. 8 is a fifth schematic structural diagram of an all-dry optical fiber ribbon cable provided in an embodiment of the present application. As shown in FIG. 8, in some embodiments, the all-dry optical fiber ribbon cable further includes a second buffer layer 600, the second buffer layer 600 is located between the first waterproof layer 300 and the loose tube 400.

The structure and composition materials of the second buffer layer 600 are the same as those of the first buffer layer 200, and will not be repeated here.

The second buffer layer 600 can also fix the first waterproof layer 300, further improving the structural stability of the optical unit 100, the first buffer layer 200 and the first waterproof layer 300, which is more conducive to the resistance of the optical unit 100 to external stress changes, reducing the impact of external stress changes on the optical fiber transmission performance in the fiber ribbon 110.

In addition, the second buffer layer 600 can separate the first waterproof layer 300 from the inner wall of the loose tube 400, protecting the first waterproof layer 300 from sticking to the inner wall of the loose tube 400 during extrusion molding of the loose tube 400 to affect the roundness and apparent effect of the forming size of the loose tube 400.

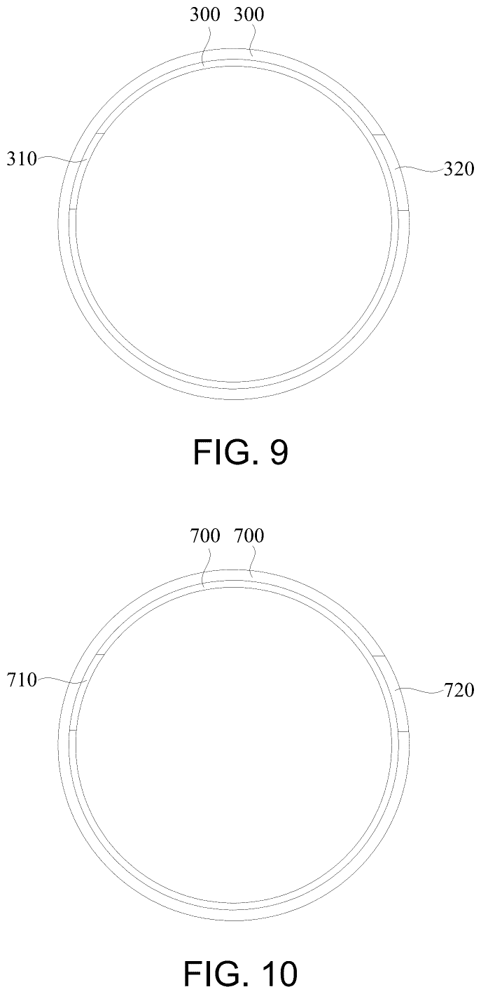

FIG. 9 is a schematic structural diagram of a first waterproof layer in an all-dry optical fiber ribbon cable provided in an embodiment of the present application. FIG. 10 is a schematic structural diagram of a second waterproof layer in an all-dry optical fiber ribbon cable provided in an embodiment of the present application. In FIGS. 9 and 10, for clarity, only two first waterproof layers 300 are shown in FIG. 9, and only two second waterproof layers 700 are shown in FIG. 10.

As shown in FIGS. 9 and 10, in some embodiments, in order to provide a better water blocking effect for the all-dry optical fiber ribbon cable, there are, at least, two first waterproof layers 300, and the two first waterproof layers 300 are sequentially wound around the first buffer layer 200, the first waterproof layer 300 located on an inner side forms a first interface 310, and the first waterproof layer 300 located on an outer side forms a second interface 320, the first interface 310 and the second interface 320 are staggered along a circumferential direction of the optical unit 100; there are, at least, two second waterproof layers 700, and the two second waterproof layers 700 are sequentially wound around the loose tube 400, the second waterproof layer 700 located on an inner side forms a third interface 710, and the second waterproof layer 700 located on an outer side forms a fourth interface 720, the third interface 710 and the fourth interface 720 are staggered along the circumferential direction of the optical unit 100.

Specifically, the first waterproof layer 300 is disposed on the first buffer layer 200 by means of winding. In order to improve the adhesion effect between the first waterproof layer 300 and the first buffer layer 200, a relationship among a circumference W₁ of the first waterproof layer 300, a diameter D₁ of a circumcircle of the optical unit 100, and a thickness H of the first buffer layer 200 is:

$${W}_{1} = \frac{π ( {D}_{1} + 2 H )}{K * ( 1 - N )} ,$$

where K is a coefficient of freedom of the optical unit 100 within the loose tube 400, and N is a transverse shrinkage rate of the first water blocking layer 300 at 200° C.-230° C. The circumcircle of the optical unit 100 is shown in FIG. 1 with a dashed line, and the diameter D₁ of the circumcircle of the optical unit 100 and the thickness H of the first buffer layer 200 are also indicated in FIG. 1.

Specifically, when laying an optical cable, the laying path of the optical cable needs to be adapted to the environment in which it is applied. The laying path of the optical cable can be straight or curved. Therefore, the optical unit 100 needs to have some activity space inside the loose tube 400 to avoid squeezing the optical unit 100 at the bend when the laying path of the optical cable is curved. Therefore, when calculating the circumference W1 of the first waterproof layer 300, it is necessary to set the coefficient of freedom K, the coefficient of freedom K ranges from 0.75 to 0.85.

When calculating the circumference Wi of the first waterproof layer 300, it is also necessary to consider the transverse shrinkage rate of the first waterproof layer 300 itself at 200°° C.-230° C. to avoid squeezing the optical unit 100 due to shrinkage of the first waterproof layer 300. The transverse shrinkage rate N ranges from 10% to 25%. Therefore, the optical unit 100, the first buffer layer 200 and the first waterproof layer 300 can be more dimensionally adapted.

When disposing multiple first waterproof layers 300, the respective first waterproof layers 300 can be wound sequentially. Each first waterproof layer 300 is coaxial with the optical unit 100. When each first waterproof layer 300 is wound, a winding interface will be formed. Specifically, as an example, two first waterproof layers 300 are sequentially wound around the outside of the first buffer layer 200, when winding a first layered first waterproof layer 300, a first interface 310 will be formed; when winding a second layered first waterproof layer 300, a second interface 320 will be formed. The second interface 320 and the first interface 310 should be positionally staggered along the circumferential direction C of the optical unit, to prevent water from infiltrating through the first interface 310 or the second interface 320.

The second waterproof layer 700 is also disposed on the loose tube 400 by means of winding. A relationship between a circumference W₂ of the second waterproof layer and a diameter D₂ of the loose tube is:

$${W}_{2} = \frac{π {D}_{2}}{1 - M} ,$$

where M is the transverse shrinkage rate of the second waterproof layer 700 at 200° C.-230° C. and ranges from 10% to 25%. The diameter D₂ of the loose tube 400 is also indicated in FIG. 1. It should be noted that the diameter D₂ of the loose tube 400 refers to the diameter of the outer ring of the loose tube 400.

When disposing multiple second waterproof layers 700, the respective second waterproof

layers 700 can also be wound sequentially. Each second waterproof layer 700 is coaxial with the optical unit 100. When each second waterproof layer 700 is wound, a winding interface will be formed. Specifically, as an example, two second waterproof layers 700 are sequentially wound around the outside of the loose tube 400, when winding a first layered second waterproof layer 700, a third interface 710 will be formed; when winding a second layered second waterproof layer 700, a fourth interface 720 will be formed. The fourth interface 720 and the third interface 710 should be positionally staggered along the circumferential direction C of the optical unit, to prevent water from infiltrating through the third interface 710 or the fourth interface 720.

In the following, the composition of the first waterproof layer 300 and the second waterproof layer 700 will be described.

The first waterproof layer 300 and the second waterproof layer 700 both includes a cross-linked polyacrylic acid resin layer, a waterproof yarn, and a polyethylene terephthalate fiber nonwoven fabric, the waterproof yarn is located between the cross-linked polyacrylic acid resin layer and the polyethylene terephthalate fiber nonwoven fabric.

The waterproof yarn is arranged in a certain quantity and linear arrangement between the cross-linked polyacrylic acid resin layer and the polyethylene terephthalate fiber nonwoven fabric. By using a dual water blocking material of the cross-linked polyacrylic acid resin layer and the waterproof yarn, water would be efficiently prevented from infiltrating longitudinally along the axial direction L of the optical unit.

Finally, it should be noted that the above embodiments are only used to illustrate the technical solutions of the present application, not to limit them; although the present application has been described in detail with reference to the foregoing embodiments, a person with ordinary skill in the art should understand that he may still modify the technical solutions recited in the foregoing embodiments or equivalently replace some or all of the technical features therein; and these modifications or replacements do not take the essence of the corresponding technical solutions out of the scope of the technical solutions of the embodiments of the present application.

What is claimed is:

1. An all-dry optical fiber ribbon cable, comprising: an optical unit, a first buffer layer, a first waterproof layer, a loose tube, a second waterproof layer, an armor layer, and a protective layer; wherein the optical unit comprises a plurality of fiber ribbons arranged in an array; and the first buffer layer, the first waterproof layer, the loose tube, the second waterproof layer, the armor layer, and the protective layer are sequentially sleeved over the plurality of fiber ribbons;
the first buffer layer is used to separate the fiber ribbons from the first waterproof layer, the first buffer layer is a high elastic polymer material layer, and a Shore hardness of the first buffer layer is 45HA-85HA, a tensile strength of the first buffer layer is greater than or equal to 10 MPA, a breaking elongation of the first buffer layer is 200%-600%, and a compression permanent deformation rate of the first buffer layer is less than or equal to 30%;
the first buffer layer comprises a plurality of first buffer portions or a plurality of second buffer portions, the plurality of first buffer portions are arranged along an axial direction of the optical unit, and there is a first spacing between two adjacent first buffer portions along the axial direction of the optical unit.

2. The all-dry optical fiber ribbon cable according to claim 1, wherein the plurality of first buffer portions are uniformly spaced along the axial direction of the optical unit.

3. The all-dry optical fiber ribbon cable according to claim 1, wherein the plurality of first buffer portions are sequentially connected end-to-end along the axial direction of the optical unit to form the first buffer layer in a spiral shape along the axial direction of the optical unit.

4. The all-dry optical fiber ribbon cable according to claim 1, wherein the first buffer portion comprises at least one first buffer strip.

5. The all-dry optical fiber ribbon cable according to claim 1, wherein the plurality of second buffer portions are arranged along a circumferential direction of the optical unit.

6. The all-dry optical fiber ribbon cable according to claim 5, wherein the plurality of second buffer portions are arranged at intervals along the circumferential direction of the optical unit.

7. The all-dry optical fiber ribbon cable according to claim 5, wherein the plurality of second buffer portions are sequentially abutted along the circumferential direction of the optical unit.

8. The all-dry optical fiber ribbon cable according to claim 7, wherein the plurality of fiber ribbons are arranged in an array to form a polygon in a cross-section of the optical unit, and a side of the second buffer portion facing the optical unit is a plane to abut against a side edge of the optical unit;
a side of the second buffer portion facing the first waterproof layer is a camber surface to abut against an inner ring of the first waterproof layer.

9. The all-dry optical fiber ribbon cable according to claim 1, wherein the first buffer layer is an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6-octadiene, 5,7-dimethyl-1,6-octadiene or 7-methyl-1,6-octadiene.

10. The all-dry optical fiber ribbon cable according to claim 2, wherein the first buffer layer is an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6-octadiene, 5,7-dimethyl-1,6-octadiene or 7-methyl-1,6-octadiene.

11. The all-dry optical fiber ribbon cable according to claim 3, wherein the first buffer layer is an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6- octadiene, 5,7-dimethyl-1,6-octadiene or 7-methyl-1,6-octadiene.

12. The all-dry optical fiber ribbon cable according to claim 4, wherein the first buffer layer is an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6- octadiene, 5,7-dimethyl-1,6-octadiene or 7-methyl-1,6-octadiene.

13. The all-dry optical fiber ribbon cable according to claim 5, wherein the first buffer layer is an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6- octadiene, 5,7-dimethyl-1,6-octadiene or 7-methyl-1,6-octadiene.

14. The all-dry optical fiber ribbon cable according to claim 6, wherein the first buffer layer is an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6- octadiene, 5,7-dimethyl-1,6-octadiene or 7-methyl-1,6-octadiene.

15. The all-dry optical fiber ribbon cable according to claim 7, wherein the first buffer layer is an ethylene-propylene rubber layer, and the ethylene-propylene rubber layer is formed by copolymerization of: monoolefin ethylene, propylene, and one or more olefin monomers from 5-ethylidene-2-norbornene, dicyclopentadiene, 6,10-dimethyl-1,5,9-undecatriene, 3,7-dimethyl-1,6-octadiene, 5,7-dimethyl-1,6-octadiene or 7-methyl-1,6-octadiene.

16. The all-dry optical fiber ribbon cable according to claim 1, further comprising: a second buffer layer, wherein the second buffer layer is located between the first waterproof layer and the loose tube.

17. The all-dry optical fiber ribbon cable according to claim 1, wherein there are, at least, two first waterproof layers, and the two first waterproof layers are sequentially wound around the first buffer layer, the first waterproof layer located on an inner side forms a first interface, and the first waterproof layer located on an outer side forms a second interface, the first interface and the second interface are staggered along a circumferential direction of the optical unit;
there are, at least, two second waterproof layers, and the two second waterproof layers are sequentially wound around the loose tube, the second waterproof layer located on an inner side forms a third interface, and the second waterproof layer located on an outer side forms a fourth interface, the third interface and the fourth interface are staggered along the circumferential direction of the optical unit.

18. The all-dry optical fiber ribbon cable according to claim 1, wherein the first waterproof layer and the second waterproof layer both comprise a cross-linked polyacrylic acid resin layer, a waterproof yarn and a polyethylene terephthalate fiber nonwoven fabric, and the waterproof yarn is located between the cross-linked polyacrylic acid resin layer and the polyethylene terephthalate fiber nonwoven fabric.

19. The all-dry optical fiber ribbon cable according to claim 1, wherein a relationship among a circumference W₁ of the first waterproof layer, a diameter D₁ of a circumcircle of the optical unit, and a thickness H of the first buffer layer is:
$${W}_{1} = \frac{π ( {D}_{1} + 2 H )}{K * ( 1 - N )} ,$$
a relationship between a circumference W₂ of the second waterproof layer and a diameter D₂ of the loose tube is:
$${W}_{2} = \frac{π {D}_{2}}{1 - M} .$$

20. The all-dry optical fiber ribbon cable according to claim 1, wherein the loose tube is made of thermoplastic polyester material formed by 30%-70% by mass of polybutylene terephthalate (PBT), 25%-60% by mass of amorphous polytetrahydrofuran (PTMG), and 5%-10% by mass of maleic anhydride or glycidyl methacrylate.
